(19) United States
(12) Patent Application Publication
(10) Pub. No.: US 2013/0325728 A1
(43) Pub. Date: Dec. 5, 2013

(54) SYSTEMS AND METHODS FOR ELECTRONICALLY JOURNALING NOTARIAL ACTS

(71) Applicant: All IP Holdings LLC, (US)

(72) Inventors: Lee Bialostok, Valley Stream, NY (US); Alexander Gruber, Brooklyn, NY (US); Louis Hyman, Pearl River, NY (US)

(73) Assignee: All IP Holdings LLC, Valley Stream, NY (US)

(21) Appl. No.: 13/857,483

(22) Filed: Apr. 5, 2013

Related U.S. Application Data
(60) Provisional application No. 61/621,019, filed on Apr. 6, 2012.

(51) Int. Cl. G06Q 50/18; G06Q 10/06

(52) U.S. Cl. CPC G06Q 50/18; G06Q 10/06
USPC 705/311

(57) ABSTRACT

A system and method is disclosed for electronically journaling notarial acts using a mobile device. The method includes capturing within a mobile application electronic evidence of the notarial act including, for example, date, time, GPS generated location, magnetic stripe reading (or 2d/3d/QR barcode scan) or image of a signer's government issued identification. The method also includes verifying the authenticity of the government identification and verifying the identity and physical presence before the notary of the individual whose signature is being notarized. The method also includes transmitting an encrypted version of the evidence from the mobile device to a web application, and verifying that the evidence has been stored electronically in a database in a non-modifiable, chronological—sequential manner that is retrievable and decryptable by the notary or other officially authorized parties.

### CROSS-REFERENCE TO RELATED APPLICATIONS

This application claims the benefit of priority under 35 U.S.C. Sec. 119(e) of U.S. Provisional Patent Application No. 61/621,019, entitled “SYSTEMS AND METHODS FOR ELECTRONICALLY JOURNALING NOTARIAL ACTS” filed Apr. 6, 2012 which is hereby incorporated by reference as if set forth in its entirety herein.

### BACKGROUND

Recent legal cases have highlighted concerns about how documents are—or are not—properly notarized. The failure to properly notarize legal documents that are submitted to courts and recording offices has led to losses of billions of dollars in the banking and real estate industries, for example. The conventional process for journaling notarial acts and auditing for notarial misconduct is inadequate and inefficient, making it difficult to prevent or uncover verifiable improprieties.

Historically, notarizations have been largely based on the honor and integrity of the notary. Conventionally, notaries have not been called upon to produce their records of their notarial acts unless and until there is a question or challenge to the authenticity of a notarization on a document.

Notarial acts are overseen by a “notary public,” or a “notary.” A notary public is an individual who is authorized by state law to witness and authenticate the signing of documents, administer oaths and affirmations, take affidavits and statutory declarations, take acknowledgments of deeds and other conveyances, and perform certain other official acts depending on the particular jurisdiction. Any such “notarial act” is known as having a document notarized or a notarization. Having a document notarized helps to prevent fraud and forgery and provides confidence that a signature is authentic and was made voluntarily. Notaries establish the bona fides of signatures and are a critical part of many legal, commercial, and financial transactions.

While the notarization process varies in each state, state notary laws and procedures share a number of important basic requirements. These requirements typically include the following “Basic Requirements For Notarial Acts:” (1) the signer must appear in person before the notary public; (2) the notary public must diligently verify the identity of the signer; and (3) the notary public must comply with jurisdictional requirements for journaling or memorializing their notarial acts. Steps (1) and (2) are known to be fairly straightforward among jurisdictions. The conventional method for execution of step (1) and step (2) requires a notary to visually verify “Evidence” which includes the physical presence of the signer and the signer's government-issued identification. How notarial acts are journaled and memorialized in step (3) can vary widely among jurisdictions, or even among individual notaries. However, the conventional method for maintaining a “Notary Journal” is to create a record of notarial acts by reducing the evidence of the notarial act to a physical artifact; (physical paper journals are the most widespread).

While variation exists in state laws and penalties related to notarial misconduct, notarization is considered an official act in every state. Many state notary laws authorize specific criminal penalties for notarial misconduct. The penalties vary depending on the state and type of wrongdoing, and may include revocation or suspension of the notary commission and fines. Serious offenses are considered misdemeanors or felonies in many states. Additionally, notaries (or their employers or superiors) may be found financially liable for damages caused to others on account of fraudulent or negligent notarizations.

Commissioned notaries are required to follow detailed procedures when performing a notarization or notarial act. For example, each state has laws and procedures in place prescribing the identification that must be used to confirm a signer's identity, as well as the contents of a notarial certificate. The notary certificate generally contains statements about the notarial act (e.g. acknowledgment or jurat language), and information about the notary, such as the notary's name, state, title, commission number, and commission expiration date.

Presently, at least sixteen states within the United States require notaries to maintain a journal or record book of notarial acts, and many other states recommend this practice. The information that must be maintained in the journal varies by state, but such requirements often includes the date of the notarial act, the type of act performed, identifying information about the signer, how the notary confirmed the identity of the person for whom the notarization was performed, and the signature of the person for whom the notarization was performed.

Over the past decade, electronic notarizations have played an increasing role in electronic commerce and other official transactions. The 2000 Electronic Signatures in Global and National Commerce Act (E-SIGN), and a number of federal and uniform state statutes, including the NASS National E-Notarization Standards, the Uniform Electronic Transactions Act (UETA), the Uniform Real Property Electronic Recording Act (URPERA), the Revised Uniform Law on Notarial Acts (RULONA), and the Model Notary Act, have given notaries the authority to use electronic signatures in performing their duties by making electronic records and digital signatures to be deemed to be legally equivalent to paper documents and manual signatures. These new statutory acts and measures have helped to guide states in their efforts to protect the integrity of the notarization process, but while also providing flexibility for the implementation of new technology used to meet the growing demand for electronic commerce.

Notably, none of these new statutory measures have eliminated the obligation for a notary to comply with the Basic Requirements For Notarial Acts or other best practices relating to notaries. Whether paper or electronic notarizations, the same Basic Requirements For Notarial Acts still apply to a notary performing a notarial act.

### SUMMARY OF THE INVENTION

In an embodiment, a computer implemented method for electronically journaling notarial acts using one or more computing devices having a processor, a storage medium, and one or more software applications stored therein and executing in the processor is disclosed. The method includes receiving electronic evidence from a mobile device. The electronic evidence includes at least one detail of a particular notarial act, government-issued identification information presented by at least one individual whose signature is being notarized, and identifying data relating to the at least one individual. The method also includes, authenticating the government-issued identification information presented by the at least one individuals according to government ID data that is received from a government database. The method also includes verifying the particular individual's identity according to the identifying data and at least the government-issued identification information. In addition, the method includes receiving a date, time and location of the particular notarial act and storing the electronic evidence, date, time and location on a database. Furthermore, the method includes transmitting to the mobile device a notification that the electronic evidence, time, date and location has been stored electronically on the database.

In an embodiment, a system for electronically journaling notarial acts is provided. The system including one or more processors configured to interact with an electronic storage medium, and one or more software modules stored therein and executing in the processor. The software modules including a communication module that is configured to receive electronic evidence that includes at least one detail of a particular notarial act. The electronic evidence also includes government-issued identification information presented by at least one individual whose signature is being notarized and identifying data relating to the at least one individual. Moreover, the electronic evidence is obtained using a mobile computing device. The system also includes a verification module configured to receive government ID data associated with the at least one individuals, authenticate the government-issued identification information using the ID data, and also verify the identity of the at least one individual. The system also includes a storage module configured to store the electronic evidence on a database. Furthermore, the communication module is also configured to transmit, to the mobile device, a notification that the electronic evidence has been stored electronically on the database.

The present methods and systems are advantageously capable of a using a mobile electronic device to capture, within a mobile application, records of date, time, and GPS-generated location, as well as magnetic stripe reading (or 2d/3d/QR barcode scan) of the signer's government-issued identification, a digital picture of the identification held next to the signature of the individual whose signature is being authenticated, an electronic signature of the signer impressed on a touchscreen of the mobile device, an audio recording of the notary obtaining an audio oath or acknowledgment from the signer, and/or other notations in a free or structured format received and recorded to memorialize and verify the physical presence before the notary of the individual whose signature was notarized.

The present methods and systems are advantageously capable of using the mobile application housed on the mobile device to query or “call up” to a government data bank to receive information (government ID data) associated with the particular individual whose signature is being notarized in order to verify—in real time—during the notarial act the authenticity of the identification presented to the notary.

The present methods and systems are advantageously capable of using the mobile application housed on the mobile device to query or “call up” to a government data bank to verify—in real time—during the notarial act the current commission status and commission number of the notary performing the notarial act and permanently recording that information together with other proof of the notarial act.

The present methods and systems are further advantageously capable of transmitting an encrypted version of evidence captured from and/or temporarily stored on the mobile device to a web application, and verifying within the web application, that the captured evidence has been stored electronically in a secure, remote and Internet accessible data center (cloud-based) storage service, for example, in a non-modifiable, chronological, and/or sequential manner that may also be retrieved and decrypted by the notary, the notary's employer or superior or the notary's commissioning agency for auditing and compliance purposes.

The present methods and systems are further advantageously capable of allowing authorized persons pursuant to an order by a court, or authorized governmental agency, limited access to retrieve the notary's journal records as evidence admissible in a court of law (or before a arbitration of similar tribunal) pursuant to evidentiary hearsay exceptions as an Official Record or Business Record maintained in the ordinary course of the notary's business.

The present methods and systems are further advantageously capable of allowing authorized persons such as notary employers or former employers limited access to records related to the notary's employment after the notary's affiliation with the employer has terminated.

The present methods and systems are further advantageously capable of facilitating the surrender of a notary's journal records to state notary administrators or other governmental agency when the notary retires, dies or otherwise loses his or her notary commission.

Moreover, in certain implementations the system and methods described herein can impress upon a notarized document, in an area obviously and logically associated with the notary's seal, a QR code (or future adaptation of quick response code recognition). The impressed QR code can be hard linked or hyperlinked with the associated entry in the notary's electronic journal of notarial acts. Based upon the assignment by the notary of a QR code to a specific notarial act the notary can uniquely link a notarized document to the evidence recorded electronically in the notary's journal advantageously affording a court or authorized person an ability to instantaneously recall/retrieve evidence of the notarial act including, voice recordings of the signer affirming their free will, signer stating their oath or attestation to the truth of their signed statements, photo or video of the witnesses and other persons present during the notarial act and other information or evidence of the notarial act.

In an embodiment, a storage service for the electronic recording of evidence of notarial acts may be cloud-based record retention, and should be non-modifiable to comply with state laws and notary best practices, but also annotatable—which could include electronic stamping of the annotations—to allow for lapses in transmission of the record to the storage service in the potential event of unavailability of the mobile device, interruptions of wireless web service, mechanical failures of the mobile device, or failures or interruptions in and to the storage service. The mobile application on the device may continue to function when an Internet connection is not available, and then later synchronize the captured information with the storage service on a web-based application when an Internet connection is re-established.

The mobile application may further include account subscription functionality that allows the user to create a new account and enter payment information, if applicable, via the mobile application accessing the web application without the need for the notary to access the web application via a laptop or desktop computer, thereby significantly reducing the cost and physical requirements of using the applicant's electronic notary journaling system. The mobile application may allow for capture of payment for the notary's services by credit card, for example, utilizing a magnetic stripe reader, a secure web-based electronic payment service, or another adaptation for remote wireless capture of electronic payments that may be developed in the future for a mobile application accessing a web application, and without the need for the notary to access the web application via a laptop or desk top computer.

Systems and methods according to the present application may still further include capabilities for capturing, storing (locally, in a temporary fashion, and/or remotely), transmitting, and indexing audio and/or digital video recordings of a signatory during the notarial act, a digital thumb print, and/or other biometric data of the signer as evidence that may be transferred to the web application for storage.

### BRIEF DESCRIPTION OF THE FIGURES

FIG. 1 illustrates an example of a system for journaling notarial acts electronically on a web server, in an embodiment.

FIG. 2 is a flowchart illustrating an example of a process of creating an electronic notary journal/log book, in an embodiment.

FIGS. 3A-3B are a flowchart series illustrating examples of processes of journaling and/or searching notarial acts electronically, in an embodiment.

### DETAILED DESCRIPTION OF THE FIGURES

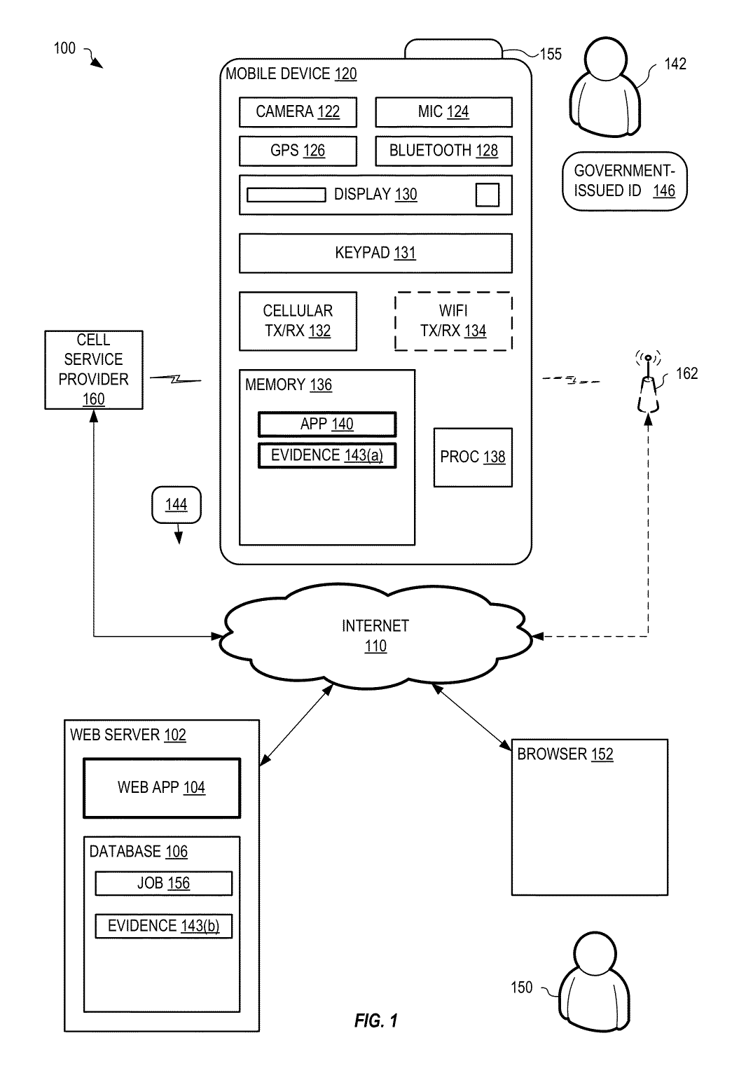

FIG. 1 illustrates an example of a system 100 for journaling notarial acts electronically on a server 102. It should be understood that although server 102 is described as a web server 102 can be any form of computing device and is not limited to a web server. Web server 102 may include a web application 104 and a database 106. Web application 104 may serve to interface database 106 with the Internet 110. System 100 may further include mobile device 120. In an embodiment, mobile device 120 is capable of communicating with web server 102 through Internet 110. According to an embodiment, mobile device 120 may include one or more of a camera 122, a microphone 124, a GPS receiver 126, a display 130, a keypad 131, a cellular interface 132, a WiFi interface 134, a device memory 136, a processor 138, and a magnetic stripe reader 155.

Mobile device 120, can be, for example, an easily portable electronic device such as a smart phone, a personal digital assistant, or a laptop or tablet computer. Display 130 may be a standard screen-imaging device, or a touchscreen display having keypad 131 implemented and integrated with the display itself In embodiments where display 130 is a touchscreen, the touchscreen may be sensitive for impression by a signer 142 to record the signer's signature by stylus (not shown) or the signer's finger. Magnetic stripe reader 155 may be attached to mobile device 120 and programmed to capture information from the signer's government-issued identification 146, if available, or credit card information from the signer or the notary. Other accessory devices (not shown) may also be attached to mobile device 120 to capture biometric data of signer 142, including the pressure and stroke speed of the signature (which may also be captured by an advanced touchscreen of display 130), and/or thumb print impression of the signer.

According to an embodiment, a notary public 150 who wishes to journal notarial acts electronically on web server 102 may follow a process outlined for the notary on a mobile application 140 that may be loaded on or programmed into mobile device 120. Mobile application 140 may be executed within mobile device 120 by processor 138, and may also have the capability to interact with notary 150, using display 130 and keypad 131. Mobile application 140 may have the further capability to capture evidence 143a of notarial acts within the mobile application 140 through use of one or more of the integrated sub-devices, described above, of mobile device 120. In an example of operation, mobile application 140 may send evidence 143a as a message 144 to web application 104 through Internet 110, and web application 104 may then store the received message 144 as evidence 143b within database 106.

Although the disclosed embodiments are described in relation to a mobile device 120 and server 102, it should be understood that embodiments of the subject matter described in this specification can be implemented on one or more devices, and as one or more computer programs, i.e., one or more modules of computer program instructions, encoded on computer storage medium for execution by, or to control the operation of one or more computing devices including mobile device 120 and server 102. Moreover, the programs/modules can execute entirely on server 102 or mobile device 120, as a stand-alone software package, partly on server 102 and mobile device 120, or entirely on another computing/device or partly on another remote computing/device. In the latter scenario, the remote computing device can be connected to process controller through any type of direct electronic connection or network (for example, through the Internet).

Referring still to FIG. 1, mobile application 140 may transmit evidence 143 via Internet 110 from Mobile device 120 to the web server 102. Under control of mobile application 140, mobile device 120 may include in recorded evidence 143a a variety of information from several sources, including but not limited to, name, address, date of birth, physical description, serial or identification number copied from government-issued identification 146 of signer 142, date, time and location obtained through use of GPS receiver 126, automated query or call up results from the mobile app to a government data base (not shown) to verify the authenticity of the government issued identification presented during the notarial act, signature of signer 142 by impressing the signer's signature on a touch-sensitive screen of display 130, still images or video recordings obtained by camera 122 (which can include sound obtained from microphone 124), audio recordings by microphone 124, names of subscribing witnesses (not shown), if any, recorded by notary 150, by typing in a relevant name on the keypad 131, for example.

Additional information about the notarial act, may be optionally obtained by notary 150 typing the additional information on the keypad 131 for recordation in an additional comments field under the control of the app 140.

In an example of operation, when ready to journal a notarial act, notary 150 may initiate operation by pressing an icon on display 130 of mobile device 120 to launch the mobile application 140 into a recording mode that can capture and store locally in memory 136, as evidence 143a, one or more of: (i) a digital picture of signer's government-issued identification 146 (e.g., a driver's license) annotated with a date, time, and location of mobile device 120 using the GPS receiver 126; (ii) a magnetic stripe reading, using magnetic stripe reader 155, of data (not numbered) embedded on identification 146 annotated with date, time, and location of mobile device 120; (iii) a digital scan, using 2d/3d or QR scan technology (not shown) loaded on mobile device 120 by mobile application 140, of data embedded on identification 146 annotated with date, time, and location of mobile device 120; (iv) metadata from a government data base (not shown) that verifies that the notary authenticated the identification of the person whose signature is being notarized in real time during the notarial act; (v) an audio recording, using microphone 124, of an audible acknowledgment by signer 142 of signer's physical presence before notary 150 and/or signer's “free will” in affixing signer's signature to a notarized document; (vi) a video recording, using camera 122, alone or in combination with microphone 124, of signer 142 committing a notarial act; (vii) a manual entry, using keypad 131 and/or or display 130, of other information related to the notarial act. Mobile device 120 can thus be configured to record evidence 143a of the notarial act during the actual interaction between notary 150 and signer 142. Notary 150 may then terminate the recording mode after the notarial act is completed and then commence the electronic journaling of the notarial act by transmitting, through cellular interface 132 or WiFi interface 134, evidence 143a to web server 102 through Internet 110.

It should be understood that a magnetic stripe reading of the government-issued identification, a barcode scan of the government-issued identification, a digital picture of the government-issued identification and the like can be referred to as government-issued identification information.

Similarly, a digital picture of the individual, a digital picture of the individual's signature, an electronic signature of the individual impressed on a touchscreen of the mobile device, an audio recording of an oath or acknowledgment from the individual, other notations in a free or structured format received and recorded by the mobile device to memorialize and verify a physical presence of the individual before the notary during the notarial act and the like can also be referred to as identifying data.

Accordingly, by including a capability of recording, live and in real time, evidence 143a of the notarial act, mobile application 140, operating on mobile device 120, thus provides an easily portable, yet inconspicuous, solution to the conventional problems noted above. Mobile application 140, and the system 100 on which it functions, can operate by either instantly (or near-instantaneously) transmitting the evidence 143a to web application 104 or locally storing evidence 143a in memory 136 until connection to the web server 102 is re-established if Internet 110 is not available to mobile device 120. Mobile application 140 may, in an embodiment, transmit evidence 143a automatically to Internet 110 once connectivity is re-established, for example, by cellular interface 132 directly, or indirectly by WiFi interface 134 connecting with a WiFi hotspot 162. In an embodiment, mobile application 140 may also prompt notary 150 to transmit evidence 143a when WiFi hotspot 162 is detected, or a cellular connection is available.

According to the embodiments described herein, mobile application 140 may advantageously provide notary 150 (as well as the notary's employer(s) or superior(s)) and signer 142 several additional levels of protection against criminal, civil, administrative, or financial liability based on allegations of notarization of fraudulently-signed documents, or notarization of a signature on a document when signer 142 was not physically present before notary 150 during the notarial act. Such additional protection can be understood with respect to the following examples.

### Example 1

Mobile application 140 may capture a digital picture or electronic scan of government-issued identification 146, annotated or embossed with the date, time, and GPS location of mobile device 120 during the notarial act. The physical presence of the government-issued identification 146 of signer 142, in the same immediate location of the mobile device 120 of notary 150 would be considered highly indicative evidence of the physical presence of signer 142 before notary 150 during the notarial act. Mobile application 140 may be capable of prompting notary 150 to capture the digital picture or scan.

### Example 2

Notary 150 can record a digital photograph of the signature of the signer 142 on the document being notarized, held next to government-issued identification 146, further memorializing the physical presence of signer 142 before notary 150, and actually recording such memorialization in memory 136 of mobile device 120. Mobile application 140 may be capable of prompting notary 150 to capture the digital photograph.

### Example 3

The mobile application can be programmed to query or call up a government data bank (not shown) to receive information (government ID data) associated with the particular individual whose signature is being notarized in order to verify the authenticity of the government issued identification presented by the person whose signature is being notarized in real time during the notarial act.

### Example 4

Magnetic stripe reader 155 (or 2d, 3d, or QR code scan reader, if applicable) can be functionality loaded to interact with mobile device 120 by the Mobile application 140 (or may be integrally included with mobile device 120, as some such mobile devices now include) to immediately authenticate government-issued identification 146, thereby creating another indicia of evidence that signer 142 is physically present before notary 150. Mobile application 140 may be capable of prompting notary 150 to verify the authenticity of identification 146, if applicable.

### Example 5

Microphone 124 may be utilized to capture and record in memory 136 an audible acknowledgment by signer 142 of signer's physical presence before notary 150, as well as the signer's free will and/or knowledgeable intent to affix a signature to a notarized document. The audible recording may be stamped with the date, time, GPS location, or relevant metadata to further memorialize the physical presence of signer 142 before notary 150. Mobile application 140 may be capable of prompting notary 150 to request an audible recording from signer 142, and to also obtain signer's permission to be audibly recorded, according to the laws of the local jurisdiction. The voice recording can be cross referenced against future supported data bases to authenticate the voice of the signer.

### Example 6

Camera 122 may be utilized to capture and record a digital video recording (alone or in combination with microphone 124) of signer 142 committing a notarial act, as well as any witnesses to the notarial act, before notary 150. Mobile application 140 may be capable of prompting notary 150 to request a video recording of signer 142 and potential witnesses, and to also obtain signer's permission to be visibly recorded, according to the laws of the local jurisdiction.

### Example 7

Magnetic stripe reader 155 (or 2d, 3d, or QR code scanner, if applicable) may be programmed to accept a credit card payment by the signer 142 before or after the completion of the notarial act. The physical presence of the signer's credit card, in the same immediate location of the mobile device 120, may be considered further indicative evidence of the physical presence of signer 142 before notary 150 during the notarial act. Mobile application 140 may be capable of prompting notary 150 to ask for a credit card payment from signer 142.

### Example 8

A touchscreen of display 130 may be programmed, in cooperation with mobile application 140, to record a signature of the signer 142 electronically, by having signer 142 physically impress the signature on a touch-sensitive surface of display 130 with a stylus or finger. Mobile application 140 may be capable of prompting notary 150 to ask for the signature.

### Example 9

Mobile application 140 may be programmed to include an “additional comments” for notary 150 to enter additional information relevant to the notarial act by entering such information on the keypad 131 or display 130. Such additional information may include a physical description of signer 142 with a plurality of descriptors (e.g., height, hair/eye color, build, noticeable distinguishing features, etc.), and/or descriptions of subscribing witnesses, other persons present, or information that may be important during the notarial act.

### Example 10

Magnetic stripe reader 155, or a similar biometric scanner, may cooperate with mobile application 140 to capture biometric details about signer 142, such as a fingerprint, to record in memory 136. Such biometric data will also be considered highly indicative evidence of the physical presence of signer 142 before notary 150 on a specific date, time, and precise location (which can be annotated or embossed with the other data, as described above) where the mobile device 120 of the notary 150 was located during the notarial act.

### Example 11

Nearly simultaneous with the notarial act, and collection of evidence 143a by notary 150, as described above, mobile device 120 may capture and emboss/annotate on evidence 143a the date, time, and location of the notarial act using GPS receiver 126. The capture of the date, time and place using GPS receiver 126 will be considered to be highly indicative evidence by an objective, independent third Party of contemporaneous verification of the notarial act.

According to the methods and systems disclosed herein, reporting of a notarial act may also be accomplished in a significantly more efficient and reliable manner. For example, through communication with web server 102, mobile application 140 is capable of transmitting and reporting each notarial act to web application 104 for storing in an electronic journal format. Web application 104 may then generate a report of the notarial act or the activity of notary 150. In an embodiment, web application 104 may record, within database 106 (or a separate storage service), information reported and/or evidence recorded electronically by mobile application 140 in a chronological, sequential, non-modifiable structured journal format consistent with the type of information presently manually recorded in conventional notary journals. Notary 150 may access web application 104, through mobile application 140 or a password-protected website, to retrieve activity reports that can be produced at the notary subscriber's request, periodically, or automatically, once the steps for recording information for journaling notarizations has been completed, according to the laws and procedures of the relevant jurisdiction.

As described above, notary 150 may utilize a browser 152 to interact with web application 104 running on web server 102 via Internet 110, instead of or in addition to interaction through mobile device 120. In an embodiment, notary 150 interacts with web pages presented by web application 104 from web server 102 to retrieve or submit journaled information from the database 106.

According to the embodiments described above, the present systems and methods realize significant additional advantages over conventional systems and methods in that mobile application 140 may facilitate the gathering of information and evidence in real time, and by objective independent third parties to provide reliable contemporaneous verification of the notarial act. The types of relevant information so gathered include, but are not limited to name, address, date of birth, physical description, serial or identification number copied from government-issued identification 146 of signer 142, date, time and location obtained through use of GPS receiver 126, automated query or call up results from the mobile app to a government data base to verify the authenticity of the government issued identification presented during the notarial act, signature of signer 142 by impressing the signer's signature on a touch-sensitive screen of display 130, still images or video recordings obtained by camera 122 (which can include sound obtained from microphone 124), audio recordings by microphone 124, names of subscribing witnesses (not shown), if any, recorded by notary 150, by typing in a relevant name on the keypad 131, for example. When stored as evidence 143a and 143b, in either or both memory 136 of mobile device 120 and database 106 of web server 102, respectively, stored information may have attached to it additional verification information from objective third parties such as a cellular service provider 160, web server 102, or a program such as Google Maps, etc.

By including such verification information with stored evidence 143a/143b, proof of compliance does not have to be completely reliant upon only information manually entered by notary 150. Specifically, the recorded information can be derived from and verified by objective data (time stamp, GPS locations, etc.) from independent and objective reliable sources, thereby avoiding problems that can arise from human error or human misinformation. The conventional systems described above rely solely on manually entered data input from a notary public to verify compliance. According to the present systems and methods, even manually-entered evidence from notary 150 can be objectively verified to have been recorded on a specific date and time contemporaneous with the notarial act, and at a precise, verifiable location before notary 150.

Mobile device 120 may further include a capability to photograph and/or scan documents into evidence 143a, convert the documents into a desired format (PDF, for example), and then directly e-mail and/or upload the document from evidence 143a to web application 104 for additional electronic storage or filing as evidence 143b. According to this embodiment, notary 150 does not need to carry or locate a separate computer and scanner to perform similar functions, as would be required by conventional electronic recording systems.

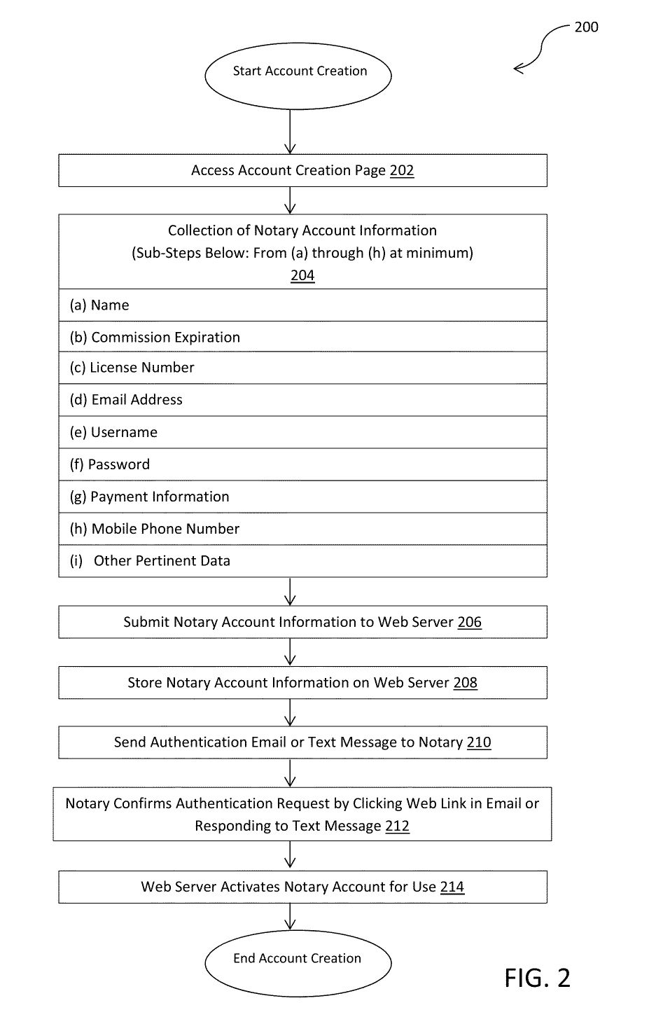

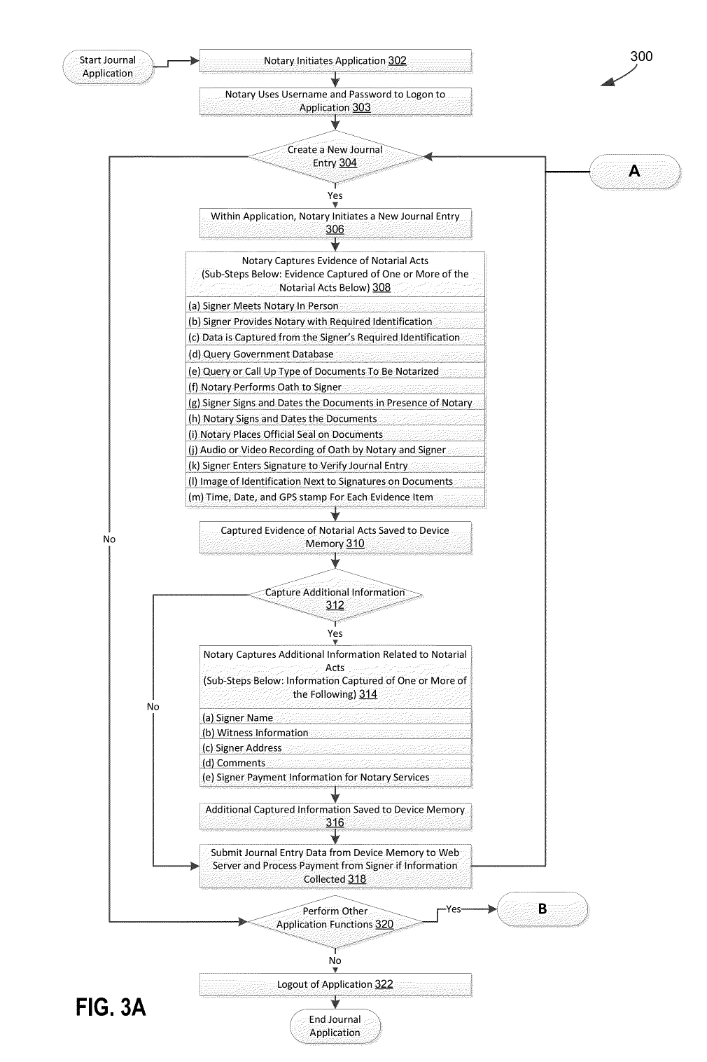

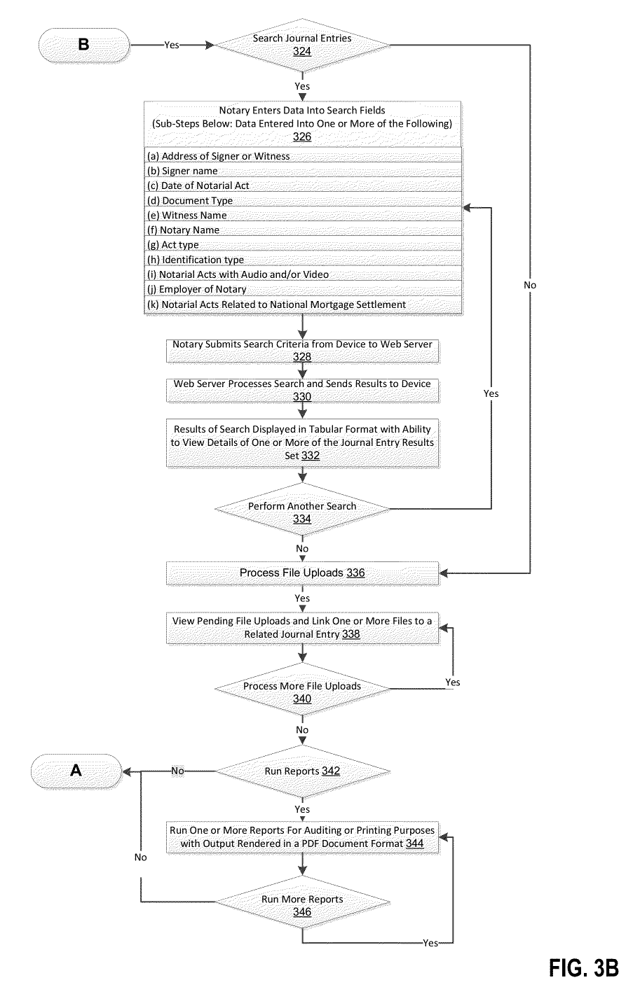

Referring now to FIGS. 2 and 3, examples of processes are described with respect to elements of system 100 of FIG. 1, in an embodiment. One of ordinary skill in the art, after reading and comprehending the present application, will understand how individual elements of system 100 may be optional to implement the following embodiments.

FIG. 2 is a flowchart illustrating an example of a process 200 of creating an electronic notary journal/log book on a web server (web server 102, for example), in an embodiment. According to process 200, a notary 150 may first create an account with a web-based service (web application 104, for example) by subscribing to the service by entering information on account page that may be accessed on either a mobile application (application 140, for example) using a mobile device (mobile device 120, for example), or through a browser (browser 152, for example), both of which may access the web application running on a web server. The following processes will refer to elements of system 100 (FIG. 1) by way of example and illustration.

In an embodiment, to create an electronic notary journal account, a notary 150 may first access a web page for web server 102 or web application 104. For example, notary 150 may start account creation by accessing an Account Creation Page in step 202 of process 200. Once accessed, process 200 will allow notary 150 to advance to step 204 to collect notary account information. Such notary account information may include one or more of the following pieces of information from/about notary 150: (a) name; (b) commission expiration; (c) notary license number; (d) email address; (e) a username for accessing web application 104; (f) a password; (g) payment information (and/or recurring payment authorization); (h) the mobile phone number (e.g., for accessing web application 104 from mobile device 120); and (i) other relevant information that may be desired by the service or notary. One of ordinary skill in the art, after reading and comprehending the present application, will appreciate that some of notary account information entered in step 204 may be optional, and that some or all may be entered during the initial launch of applications 104 and 140 by notary 150, and may not need to be entered again apart from verification purposes.

Once desired and/or required notary account information in step 204, process 200 advances to step 206 to submit the entered notary account information to web server 102. Upon submission, process 200 may advance to step 208 to store the submitted notary account information on web server 102. Once successfully stored, process 200 may advance to step 210, where web application 104 may send an authentication email and/or text message to notary's entered email address (if applicable) and/or mobile device 120, respectively. Once the authentication is received by notary 150 in step 210, notary 150 may confirm the authentication request in step 212. Step 212 may be performed, for example, by notary 150 clicking a web link in the email, or by responding to the text message, received in step 210. After the authentication request is confirmed, web server 102 or web application 104 may, in step 214, activate the notary account to create and use the electronic notary journal account, and thus complete the account creation process 200. Once so created, notary 150 may use the electronic notary journal in place of, or in addition to, the conventional physical notary journal described above. Process 200 may be executed by notary 150 through mobile device 120 (if Internet-accessible) or browser 152.

FIG. 3 is a flowchart illustrating an example of a process 300 of journaling notarial acts electronically on a web server (web server 102, FIG. 1, for example), in an embodiment. Referring now to FIG. 3A, according to process 300, notary 150 may interact with mobile application 140 to prompt or allow notary 150 to capture evidence 143a on mobile device 120 for transfer to web application 104 and web server 102 for retrievable and searchable storage in database 106. Process 300 may be implemented in accordance with some or all of the following steps once notary 150 has created a usable electronic notary journal on web server 102.

Step 302 is a necessary step. In an example of step 302, notary 150 may initiate a new entry for the electronic notary journal by initiating mobile application 140 on mobile device 120. Notary 150 may initiate application 140 by selecting an appropriate icon (not shown) on display 130 (in which case mobile device 120 may itself be password-protected against misuse), or optionally by entry of username and password to logon to mobile application 140, and thereby web application 104 through interaction of the two applications by way of Internet 110. In an example of step 302, notary 150 may also logon to web application 104 through browser 152 and Internet 110.

Once web application 104 and/or mobile application 140 are accessed, process 300 proceeds to step 304. Step 304 is a decision step. In an example of step 304, notary 150 may choose whether to create a new electronic journal entry. If notary chooses to create a new journal entry, process 300 will proceed to step 306. If notary 150 chooses not to create a new entry to the electronic notary journal, process 300 proceeds to decision step 320.

In step 306, notary 150 may, within mobile application 140, initiate a new journal entry for a particular notarial act or group of notarial acts. Once so initiated, process 300 may advance to step 308. In an example of step 308, notary 150 may capture and/or record evidence 143a of a particular notarial act or acts. Examples of captured evidence 143a collected in step 308 include, but are not limited to: (a) signer 142 meets with notary 150 in person; (b) signer 142 provides notary 150 with required identification 146; (c) utilizing camera 122 (or other scanning capabilities of mobile device 120 notary 150 electronically creates a record of the identification 146, presented by signer 142 at the notarial act, into memory 136 on mobile device 120 (and/or other data from identification 146 may be manually entered by notary 150 into appropriate fields of mobile application 140 on display 130); (d) mobile app is programmed to query or call up to a government data base to verify the authenticity of the government issued identification presented by the person whose signature is being notarized; (e) notary 150 identifies type of document(s) to be notarized (which can be selected by notary 150 from a menu of standard document types shown by mobile application 140 on display 130); (f) notary 150 performs oath to signer 142 in the case of a jurat or affirmation; (g) signer 142 signs and dates the relevant document(s) in the presents of notary 150; (h) notary 150 signs and dates the relevant document(s); (i) notary places an official seal on the relevant document(s); (j) notary 150 records notary and signer 142 performing the oath by audio and/or video capture (this feature may ensure the oath is actually given to signer by notary, which is rarely verified in conventional practice); (k) signer 142 may enter a signature on display 130 for transfer to electronic notary journal, to personally verify the journal entry by notary 150; (l) a picture of the signer's government-issued identification 146 (e.g. drivers' license) next to the actual signatures on the relevant documents (or a picture of the 2d/3d/QR code) can be photographed or scanned into memory 136 (a preview of the image may be made immediately available to notary 150 to determine if the quality of the picture is sufficient); and (m) the time, date, and GPS stamp can be annotated or embossed on each of the evidence 143a items captured during the notarial acts.

Moreover, in certain implementations, the various methods and systems described herein can be configured to require one or more verifications (such as against one or more databases, such as the government database referenced above) prior to enabling a certification of one or more documents and/or transactions such as notarial acts. In other implementations, such verifications can be required prior to enabling storage of one or more documents and/or transactions such as notarial acts in a particular database. In doing so, the system can ensure that only documents and/or transactions that have been independently verified are certified/stored as notarized documents/transactions.

Moreover in certain implementations, the various methods and systems described herein can be configured to process a comparison of the signer's photo ID against a picture of the signer as they sign the document to determine the degree to which the signer looks like his/her photo ID picture. If there is a discrepancy above a certain threshold, the signer's identity will be scrutinized and require additional verifications, and/or negate or flag the notarization of the document.

Moreover in certain implementations, the various methods and systems described herein can be configured to process a comparison of photographs found on the internet of the person whose signature is being notarized with the information on the signer's government issued government identification to determine if the signer is the same person as verified by the comparison. If there is a substantial discrepancy the system can be programmed to automatically require additional verification of identity.

Moreover in certain implementations, the various methods and systems described herein can be configured to process a comparison of the notary's mobile device geo-tag the signing parties residence as indicated on their government issued identification to alert the notary to increase their level of diligence in verifying the identity of the person whose signature is being notarized. The system may be programmed to automatically alert the notary to request additional verification of identity or flag the notarial certificate.

Moreover in certain implementations, the various methods and systems described herein can be configured to process a comparison of information available regarding the individual whose signature is being notarized found on the internet, such as social networking profiles, blogs, websites, public records, photographs with the information on the signer's government issued government identification to determine if the signer is known to be associated with that address, or at a minimum the same city/state. If not, the system may be programmed to automatically require the notary to obtain additional verification of the signer's identity.

Upon completion of the notarial acts and the collection of related evidence 143a in step 308, process 300 may proceed to step 310, where notary 150 may save captured evidence 143a into memory 136 (this feature may include a standard procedure to capture the signature, and may be used as a substitute for signer 142 signing the notary's physical journal/log book). In an example of step 310, application 140 may transmit, through Internet 110, evidence 143a, as message 144, to web server 102. In a further example of step 310, mobile application 140 may verify that evidence 143b has been stored in memory 136 and/or database 106.

Step 312 is a decision step. In an example of step 312, notary 150 may choose whether to capture and store in memory 136 additional information related to notarial acts. Step 312 may be performed, in an embodiment, in response to a prompt by mobile application 140. If notary 150 chooses to enter additional information, process will proceed to step 314. If notary chooses to not enter additional information, process 300 will proceed to step 318.

In step 314, notary 150 may, within mobile application 140, capture additional information related to the notarial acts executed above. In an example of step 314, notary 150 may capture one or more of the following: (a) Signer Name (this feature could supplement or replace the signer's name being manually printed in the notary's physical journal/log book); (b) Witness Information can be added, as described above, when necessary or desired for a particular document (this feature is not presently performed in the art with respect to notary journals); (c) Signer Address (this field may replace the address section of the notary log); (d) Comments (this field may be used to capture and/or record other information that notary 150 desires to add to the electronic searchable record of the notarial act(s)); and (e) Payment Information (of signer so that the notary can collect payment from the signer for notary services, or of notary 150 if applicable). In an embodiment, step 314 may also include a prompt in mobile application 140 for notary 150 to enter any or all of the additional items of information.

After entry of additional information in step 314, process 300 proceeds to step 316 to save the entered information into memory 136 of mobile device 120 as part of evidence 143a. In an example of step 316, mobile application 140 may automatically save the entered information. In another example of step 316, mobile application 140 may prompt notary 150 to save the entered information individually or collectively. Once saved locally into memory 136, mobile application 140 may, in step 318, submit saved evidence 143a (captured evidence saved in step 310 and/or saved information from step 316) from memory 136 as message 144 through Internet 110 to web server 102. Step 318 may additionally include a sub-step of processing a payment from signer 142 if information if desired. In an embodiment, payment processing may be performed as a separate step (not shown). Step 318 may include an additional sub-step of assigning a unique QR code (or future adaptation of quick response code) thereby hard-linking or hyperlinking a specific notarized documents to the evidence of the notarial act captured simultaneously with the notarial act. Step 318 may also be performed at a later time, or postponed if a cellular or WiFi connection (i.e., through interfaces 132, 134) is not available. After completion (or postponement) of step 318, process 300 may return to decision step 304, and the steps described above may be repeated until notary 150 chooses to create no, or no further, electronic journal entries, upon which choice process 300 may proceed to step 320.

Step 320 is a decision step. In an example of step 320, notary 150 may choose, or be prompted to choose, whether to perform other functions of mobile application 140. If notary 150 chooses to perform other functions of mobile application 140, process 300 may proceed to step 324 (FIG. 3B, as represented by element B in FIG. 3A). If notary 150 chooses to perform no additional functions of mobile application 140, or notary 150 simply wishes to close mobile application 140 (or a similar application on browser 152), notary 150 may, in step 322, logout of web application 104 by selecting an appropriate key or icon (not shown) on display 130 and thereby end process 300.

Referring now to FIG. 3B, notary 150 may perform additional functions of process 300, if selected in step 320 (FIG. 3A). If additional functions are selected, process 300 may first proceed to step 324. Step 324 is a decision step. In an example of step 324, notary 150 may choose (or be prompted to choose) whether to search through entries by notary 150 into the electronic notary journal (see FIG. 2, for example). If notary 150 (or another user, such as an authorized administrator or court agent) chooses not to search through journal entries, process 300 may proceed to step 336 to perform additional application functions, if desired.

Upon selection of search functions in step 324, notary 150 may then, in step 326, enter one or more pieces of data into search fields selected by notary 150 or prompted by mobile application 140 on display 130 (or browser 152). Such data search fields may include, but are not limited to, one or more of the following: (a) address of signer 142 and/or one or more witnesses (if applicable); (b) name of signer 142; (c) date of notarial act; (d) document type; (e) witness name; (f) name of notary 150; (g) type of notarial act; (h) type of identification 146; (i) notarial acts that contain audio and/or video recordings with evidence 143b; (j) employer of notary 150 (which may be of particular importance for an employer—law firm, bank, corporation, etc. —who employ or utilize the services of more than one notary); and (k) notarial acts related to a specific issue (e.g., a national mortgage settlement, of which key words relating to the issue could be included in the Comments field, described above).

Once data search fields are selected by notary 150 in step 326, the selected search criteria may be submitted, in step 328, from mobile device 120 to web server 102 through Internet 110. Process 300 may then proceed to step 330, where web application 104 may then, in step 330, process a search according to the submitted search criteria and send results of the search to mobile device 120 or browser 152. Search results may also be sent to mobile device 120/browser 152 in a separate step (not shown).

According to an embodiment, the search functions described above would advantageously allow a notary (or an auditor/agent on behalf of (i) the notary's employer or superior, (ii) a notarial commission agency, or (iii) a court or quasi-judicial tribunal) to quickly retrieve information about a single notarial act or multiple notarial acts. Searches may be performed one data search field at a time, or according to multiple data search fields simultaneously in order to narrow the search parameters.

Once the search is processed and results are received by mobile device 120/browser 152 in step 330, mobile application 140 may then, in step 332, display the search results in tabular format on display 130 (or browser 152). In an example of step 332, the search results may be displayed with an additional capability to view details of one or more of the electronic journal entry data fields. Such additional capability may allow for the search results to be displayed in a table format with each individual record being accessible to view individual fields relating to captured audio, scans, signatures, time, dates, GPS locations, singer names, notary names, driver's license information, witness names, document types, and other comments.

In an embodiment, notary 150 may then, in step 334, choose (or process 300 may then prompt notary 150) to perform another search. Step 334 is thus a decision step. If notary performs another search, process 300 will repeat steps 326 through 334. If no further searches are desired or chosen, process 300 will proceed to step 336.

In step 336, process 300 may process the file uploads submitted by mobile application 140. Step 336 may be performed automatically upon connection to Internet 110 (by WiFi or cellular connection), manually after selection by notary 150, or mobile application 140 may prompt notary to upload evidence 143a into web server 102. In an embodiment, process 300 may, in step 338, automatically display (or prompt notary 150 to view) pending file uploads and link one or more files to a related journal entry. In an example of step 338, notary 150 may upload and process all pending files, or one or more pending files individually.

According to step 336, notary 150 may send files to web server 102 by: (a) uploading documents through Internet 110 and web application 104; and/or (b) sending an email (not shown) with attached file(s) to a desired specific email address (web server 102 may be programmed in advance to recognize the specific email address of notary 150, for example, and thereby save the attached file(s) to the electronic notary journal account of notary 150). Each file thus sent to web server 102 may be marked as “pending” until the particular file(s) is(are) linked to a specific electronic notary journal entry. This advantageous process would thus allow storage (e.g., in database 106) of pertinent information regarding notarial acts that are not conventionally available. Files extensions that may be compatible for such storage and future retrieval include, but are not limited to pdf, doe, docx, rtf, txt, jpg, gif, png, bmp, csv, and xml.

In an embodiment, process 300 may then proceed to decision step 340. In step 340, notary 150 may (or be prompted to) choose to process more file uploads. If so chosen, process 300 may repeat steps 336 through 340. If, in step 340, notary 150 chooses to process no further file uploads, or if no further files are pending to upload, process 300 will proceed to step 342.

Step 342 is also a decision step. In an example of step 342, notary 150 may choose (or be prompted to choose) to run reports of the searches, or other information from the electronic notary journal, described above. If notary 150 chooses to run no reports, process 300 may then proceed back to step 304 (FIG. 3A, as represented by element A in FIG. 3A). If notary chooses to run reports, process 300 will proceed to step 344. In an example of step 344, notary 150 (or other authorized user) may run one or more reports for auditing or printing purposes. In an embodiment, the reports run in step 344 may be output in a PDF document format, or other format as desired by notary 150.

Process 300 may then proceed to step 346. Step 346 is a decision step. In an example of step 346, notary 150 may choose (or be prompted to choose) to run or print additional reports. If notary 150 so chooses to run/print additional reports, process 300 will proceed back to repeat step 344. If notary 150 chooses to run/print no further reports, process 300 will proceed back to step 304 (FIG. 3A, as represented by element A in FIG. 3A).

The reporting functions of the present application described above may thus be advantageously utilized to quickly retrieve multiple records at once for auditing or printing purposes. The ability to print multiple records in a PDF format, for example, would allow notaries to create physical journal entries as a supplement to the electronic journal entries described above. Such supplemental physical entries may be of particular advantageous use by notaries that are required, by their commissioning jurisdiction or their subscribing employers, to maintain a physical bound notary journal/log book according to the conventional system. The reporting functions of the present application will further allow notary 150 to quickly and efficiently produce a physical journal in a particular chronological order, for example, or other order as desired.

According to the present embodiments, electronic journaling of notarial acts advantageously may ensure the future availability of evidence 143a/143b of the notarial acts. Such evidence of a single or multiple notarial acts may further remain available in perpetuity, according to modern data storage technology, for retrieval by notary 150 or authorized individuals and/or agencies (individually and collectively referred to as “Authorized Accessors”). Examples of such Authorized Accessors include, but are not limited to, the notary's estate, the notary's employer or superior who have subscribed to the service and who have authorized access to the notary's electronic journal, authorized representatives of the notary's commissioning agency, courts and quasi-judicial entities with authority pursuant to appropriate court order or as otherwise required by laws.

According to an embodiment, the Authorized Accessors may utilize unique identifiers to access the notary's electronic journal records through browser 152, communicating through Internet 110, and interfacing with web application 104 on web server 102. Episodes of Authorized Accessors review and/or retrieval of such electronically journaled records may be recorded as medadata, capturing the identity of the Authorized Accessor, a date and time of the access, and the specific records accessed. The access to electronically journaled notary records by Authorized Accessors may be limited to only view, download, or print functionality, if desired, with no ability of the Authorized Accessor(s) to annotate or modify the records so accessed. Such access to electronically journaled notary records by Authorized Accessors thus may be advantageously limited to only (i) auditing compliance with a commissioning jurisdiction's notarial laws and regulations, (ii) auditing by a notary's employer or superiors, and/or (iii) by order of a court, quasi-judicial entity or as otherwise required by law or regulations.

Moreover, in certain implementations the systems and methods described herein can process one or more of the various documents captured (such as those captured at 306-314) in order to determine and/or assign various permissions to one or more parties (e.g. an employer, a signing party, etc.). For example, In a scenario where a notary is notarizing a loan document which is signed by both a borrower and a lending institution such as a bank, an image of the signed document (captured in the manner described in detail above) can be further processed (using techniques such as optical character recognition) in order to identify the various parties named in the document (e.g., the various parties to the transaction, the notary, the notary's employer, and/or any appropriate administrative agency that may require access to the notarized document). Based on the identification of such parties named within the notarized document, the system can assign one or more permissions, depending on the role/identity of such parties (e.g., the notary may have one level of access/authorization to view certain aspects of the notarized document and/or related information, while one of the parties to transaction reflected in the notarized document may have another level of authorization). In doing so, particular levels of access to such notarized documents can be determined and assigned in an automated fashion, without requiring manual user input in order to define such permissions for each document/transaction.

Moreover, in certain implementations the systems and methods described herein will advantageously afford a court or authorized person an ability to instantaneously recall/retrieve evidence of the notarial act including, voice recordings of the signer affirming their free will, signer stating their oath or attestation to the truth of their signed statements, photo or video evidence of the witnesses and other persons present during the notarial act and other information or evidence of the notarial.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components, method steps can generally be executed together in a single product or packaged into multiple products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. As another example, the various steps and processes described herein can be executed on one or more computing devices. By way of further example, in certain implementations the systems and methods described herein have been described as being performed by a mobile software application executing on a mobile device or a web based application executing on a web server, however, it should be understood that any such steps, or subroutines can be performed in whole or in part by any number of applications executing on one or more computing devices or a combination of the foregoing.

Changes may be made in the above methods and systems without departing from the scope hereof It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

We claim:

1. A computer implemented method for journaling notarial acts, using one or more computing devices having a processor, a storage medium, and one or more software applications stored therein and executing in the processor, the method comprising:
receiving, using a processor configured by a software application executing therein, electronic evidence including (1) at least one detail of a particular notarial act, (2) government-issued identification information presented by at least one individual whose signature is being notarized, and (3) identifying data relating to the at least one individual, wherein the electronic evidence is obtained using a mobile computing device;
for each of the at least one individuals,
querying a government database for government ID data associated with a particular individual, using the configured processor,
authenticating the government-issued identification information presented by the particular individual according to the government ID data, using the configured processor,
verifying the particular individual's identity according to the identifying data and at least the government-issued identification information, using the configured processor;
receiving, using the configured processor, a date, time and location of the particular notarial act in addition to the at least one detail of the particular notarial act;
storing, using the configured processor, the electronic evidence in association with the date, the time and the location on a database accessible by the configured processor; and
transmitting to the mobile device, using the configured processor, a notification that the at least one detail, time, date and location has been stored electronically on the database.

2. The method of claim 1, further comprising: recording, using the configured processor, the electronic evidence on a storage medium of the mobile device.

3. The method of claim 1 further comprising the steps of: creating, using the configured processor, a journal entry associated with the particular notarial act; and associating the electronic evidence, the date, the time and the location with the journal entry.

4. The method of claim 1 further comprising: receiving, using the configured processor, account information associated with a notary performing the notarial act, wherein the account information is received from the mobile device; and verifying, using the configured processor, the notary account information.

5. The method of claim 1, the at least one detail including an electronic copy of a document upon which the particular notarial act is performed.

6. The method of claim 5, further comprising: modifying, using the configured processor, the electronic copy of the document to include an electronic impression wherein the impression includes a link to the at least one detail of the particular notarial act.

7. The method of claim 5, further comprising: modifying, using the configured processor, the electronic copy of the document to include one or more annotations.

8. The method of claim 1, the at least one detail comprising at least one recordable element of the performance of the notarial act recorded contemporaneously to the notarial act.

9. The method of claim 8, the at least one recordable element comprising at least one of an audio file or a video file recorded during the step of capturing.

10. The method of claim 1, the government-issued identification information comprising at least one of a magnetic stripe reading of the government-issued identification, a barcode scan of the government-issued identification, a digital picture of the government-issued identification.

11. The method of claim 1, the identifying data comprising at least one of a digital picture of the individual, a digital picture of the individual's signature, an electronic signature of the individual impressed on a touchscreen of the mobile device, an audio recording of an oath or acknowledgment from the individual, other notations in a free or structured format received and recorded by the mobile device to memorialize and verify a physical presence of the individual before the notary during the notarial act.

12. The method of claim 1 further comprising the step of: transmitting to the mobile device, using the configured processor, an alert indicative of an authenticity of the government-issued identification information.

13. The method of claim 1 further comprising the step of: transmitting to the mobile device, using the configured processor, an alert indicative of a verification of the particular individual's identity.

14. The method of claim 1 wherein the one or more computing devices include the mobile device and a database server in communication with the database.

15. The method of claim 1 wherein the electronic evidence is stored on the database in a non-modifiable, chronological and encrypted format.

16. The method of claim 1, further comprising the steps of:
determining, using the configured processor, a proximity of the location to an address associated with the particular individual, wherein the address is obtained from the government-issued identification information or government ID data; and
transmitting, using the configured processor, an alert to the mobile device, wherein the alert is generated according to the proximity.

17. The method of claim 1, the step of verifying the particular individual's identity including the steps of:
receiving, using the configured processor, an electronic version of the particular individual's signature obtained contemporaneously to the notarial act using the mobile device;
comparing, using the configured processor, the electronic version of the particular individual's signature to another electronic signature obtained from the government-issued identification using the mobile device.

18. The method of claim 1, the step of verifying the particular individual's identity including the steps of:
receiving, using the configured processor, a digital picture of the individual obtained contemporaneously to the notarial act using the mobile device; and
comparing, using the mobile device, the digital picture to another digital picture of the particular individual obtained, using the mobile device, from the government-issued identification.

19. A system for journaling notarial acts having one or more processors configured to interact with an electronic storage medium, and one or more software modules stored therein and executing in the processor, the system comprising:
a communication module configured to receive electronic evidence including at least one detail of a particular notarial act, government-issued identification information presented by at least one individual whose signature is being notarized, identifying data relating to the at least one individual, wherein the electronic evidence is obtained using a mobile computing device; and
a verification module configured to, receive government ID data associated with the at least one individuals, authenticate the government-issued identification information according to the government ID data, verify the identity of the at least one individuals; and
a storage module configured to store the electronic evidence on the database, and wherein the communication module is further configured to transmit to the mobile device a notification that the electronic evidence has been stored electronically on the database.

20. The system of claim 19, wherein the storage module is further configured to receive search queries and execute the search queries against the indexed captured electronic evidence and generate a report including the query results.
